(19) United States
(12) Patent Application Publication
(10) Pub. No.: US 2026/0087917 A1
(43) Pub. Date: Mar. 26, 2026

(54) SAFETY ALERTING METHOD AND APPARATUS, STORAGE MEDIUM AND PROGRAM PRODUCT

(71) Applicant: Beijing Zitiao Network Technology Co., Ltd., Beijing (CN)

(72) Inventor: Zhanyi YAN, Beijing (CN)

(21) Appl. No.: 19/335,770

(22) Filed: Sep. 22, 2025

(30) Foreign Application Priority Data
Sep. 23, 2024 (CN) 202411328879.2

(51) Int. Cl. G08B 21/02; G06F 3/01; G06T 7/246; G06T 7/73; G06T 19/00

(52) U.S. Cl. CPC G08B 21/02; G06F 3/012; G06T 7/246; G06T 7/73; G06T 19/006; G06T 2210/21

(57) ABSTRACT

Embodiments of the present disclosure provide a safety alerting method and apparatus, a storage medium and a program product. The method further comprises: acquiring first state data of a plurality of key nodes of a user wearing a head-mounted device, the first state data comprising poses of the key nodes; acquiring second state data of a safety boundary; determining a prediction result of a collision based on the first state data and the second state data; generating safety alerting information according to the prediction result of the collision.

### CROSS-REFERENCE TO RELATED APPLICATION(S)

This application claims priority to Chinese Application No. 2024113288792 filed Sep. 23, 2024, the disclosure of which is incorporated herein by reference in its entirety.

### FIELD

Embodiments of the present disclosure relate to the field of extended reality technologies, and particularly, to a safety alerting method and apparatus, a storage medium and a program product.

### BACKGROUND

During the use of head-mounted devices, users might collide with objects in the real physical environment due to obstructed vision.

### SUMMARY

Embodiments of the present disclosure provide a safety alerting method and apparatus, a storage medium and a program product, to improve the accuracy and effectiveness of safety alerting and reduce user interruption in use of the head-mounted device.

In a first aspect, an embodiment of the present disclosure provides a safety alerting method comprising:
acquiring first state data of a plurality of key nodes of a user wearing a head-mounted device, the first state data comprising poses of the key nodes;
acquiring second state data of a safety boundary;
determining a prediction result of a collision based on the first state data and the second state data;
generating safety alerting information according to the prediction result of the collision.

In a second aspect, an embodiment of the present disclosure provides a safety alerting apparatus, comprising:
an acquisition module configured to acquire first state data of a plurality of key nodes of a user wearing a head-mounted device, the first state data comprising poses of the key nodes;
the acquisition module further configured to acquire second state data of an object in a real environment, the second state data comprising position and surface information of the object;
a determination module configured to determine a prediction result of a collision based on the first state data and the second state data;
a generation module configured to generate safety alerting information according to the prediction result of the collision.
In a third aspect, an embodiment of the present disclosure provides an electronic device comprising: a processor and a memory;
the memory storing computer-executable instructions;
the processor executing the computer-executable instructions stored in the memory to cause the at least one processor to perform the safety alerting method in the above first aspect and various possible designs of the first aspect.

In a fourth aspect, an embodiment of the present disclosure provides a computer-readable storage medium having stored therein computer-executable instructions which, when executed by a processor, implement the safety alerting method in the above first aspect and various possible designs of the first aspect.

In a fifth aspect, an embodiment of the present disclosure provides a computer program product comprising a computer program which, when executed by a processor, implements the safety alerting method in the above first aspect and various possible designs of the first aspect.

Embodiments of the present disclosure provide a safety alerting method and apparatus, a storage medium and a program product. The method further comprises: acquiring first state data of a plurality of key nodes of a user wearing a head-mounted device, the first state data comprising poses of the key nodes: acquiring second state data of a safety boundary: determining a prediction result of a collision based on the first state data and the second state data: generating safety alerting information according to the prediction result of the collision.

### BRIEF DESCRIPTION OF THE DRAWINGS

In order to illustrate the technical solutions in the present disclosure or the prior art more clearly, a brief introduction will be given to the figures to be used in the description of the embodiments or the prior art. It is obvious that the figures described below are merely some embodiments of the present disclosure, and other figures can also be obtained by those skilled in the art according to these figures without involving any inventive effort.

FIG. 1 illustrates a schematic diagram of an application scenario of a safety alerting method according to an embodiment of the present disclosure;

FIG. 2 illustrates a first flow chart of a safety alerting method according to an embodiment of the present disclosure:

FIG. 3 illustrates a schematic view of a plurality of key points according to an embodiment of the present disclosure:

FIG. 4 illustrates a second flow chart of a safety alerting method according to an embodiment of the present disclosure:

FIG. 5 illustrates a schematic diagram illustrating a principle of a manner for determining a fault prediction result according to an embodiment of the present disclosure:

FIG. 6 illustrates a block diagram of a safety alerting apparatus according to an embodiment of the present disclosure.

FIG. 7 illustrates a schematic diagram of hardware of an electronic device according to an embodiment of the present disclosure.

### DETAILED DESCRIPTION OF EMBODIMENTS

How to accurately and effectively alert users to ensure their safety while minimizing user interruption remains a critical technical challenge to be addressed. Technical solutions in embodiments of the present disclosure will be described clearly and completely with reference to figures in embodiments of the present disclosure to make the objects, technical solutions and advantages of the embodiments of the present disclosure more apparent. Obviously, the embodiments described are partial embodiments other than all embodiments of the present disclosure. All other embodiments obtained by those having ordinary skill in the art based on the embodiments in the present disclosure without making any inventive efforts all fall within the protection scope of the present disclosure.

When users use Extended Reality (XR) head-mounted devices, such as Virtual Reality (VR) devices, Augmented Reality (AR) devices and Mix Reality (MR) devices, they can easily become immersed in the virtual reality and lose awareness of their real physical surroundings, which might cause an accidental collision with an object in the real world when the user moves.

In the related art, in order to ensure that a user can safely use a head-mounted device, a safety boundary technology is usually employed. Specifically, the user may move freely within the safety boundary. A distance between the user and a preset safety boundary is determined based on a pose of the head-mounted device. When the user approaches the safety boundary or walk out of the safety boundary; a passthrough effect of the head-mounted device is activated to enable the user to see the external real-world environment to thereby prevent occurrence of collisions. However, in the above manner, the passthrough of the picture of the real-world environment is also often activated even when the user will not collide with an obstacle, which results in lower accuracy and effectiveness of safety alerts, as well as frequent interruptions to the user.

In order to solve the above technical problem, the Inventor of the present disclosure discovers that as compared with alerting by the passthrough of the real-world environment based on the pose of the head-mounted device and the safety boundary, predicting a region where a collision will occur soon more accurately based on the poses of the user's key nodes and passing through the relevant region purposefully to provide more effective alerting to the user can achieve a purpose of avoiding interrupting the user excessively and effectively ensuring the user's safety. In view of this, embodiments of the present disclosure provide a safety alerting method.

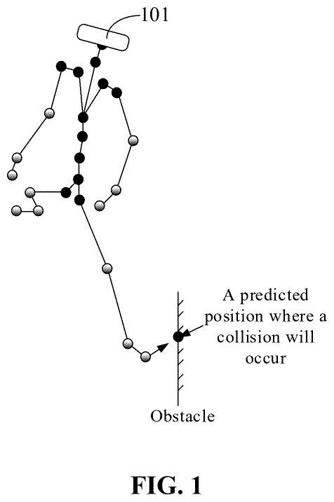

FIG. 1 illustrates a schematic diagram of an application scenario of a safety alerting method according to an embodiment of the present disclosure. As shown in FIG. 1, a user (whose full body diagram is not shown and whose key skeletal nodes are shown only) is wearing a head-mounted device 101. There is an obstacle (a stationary or moving object) in a space where the user is located. The head-mounted device 101 may be an all-in-one machine and may be connected to a terminal device such as a computer, which is not limited in the present embodiment here.

In a specific implementation process, an example is taken in which the head-mounted device 101 is an all-in-one machine. The head-mounted device 101 acquires first state data of a plurality of key nodes of the user wearing the head-mounted device, the first state data comprising poses of the key nodes, acquires second state data of a safety boundary, determines a prediction result of a collision according to the first state data and the second state data, and generates safety alerting information according to the prediction result of the collision. The safety alerting method according to the embodiments of the present disclosure, by performing collision prediction according to more detailed data of the poses of the plurality of key nodes of the user and the safety boundary, can obtain a prediction result with a higher accuracy, improve the accuracy and effectiveness of the safety alerting, can not only avoid excessive interruptions to the user but also effectively ensure the user's safety, and improve the user's experience in use.

It should to be noted that the diagram of the scenario shown in FIG. 1 is merely an example, and the safety alerting method and scenario described in the embodiment of the present application are intended to describe the technical solution of the embodiment of the present application more clearly, and do not constitute a limitation on the technical solution provided by the embodiment of the present application; those having ordinary skill in the art appreciate that the technical solution provided by the embodiment of the present application is equally applicable to similar technical problems as the system evolves and a new service scenario appears.

The technical solution of the present application will be described in detail in the following specific embodiments. The following specific embodiments may be combined with each other and the same or similar concepts or processes may not be described in detail in some embodiments.

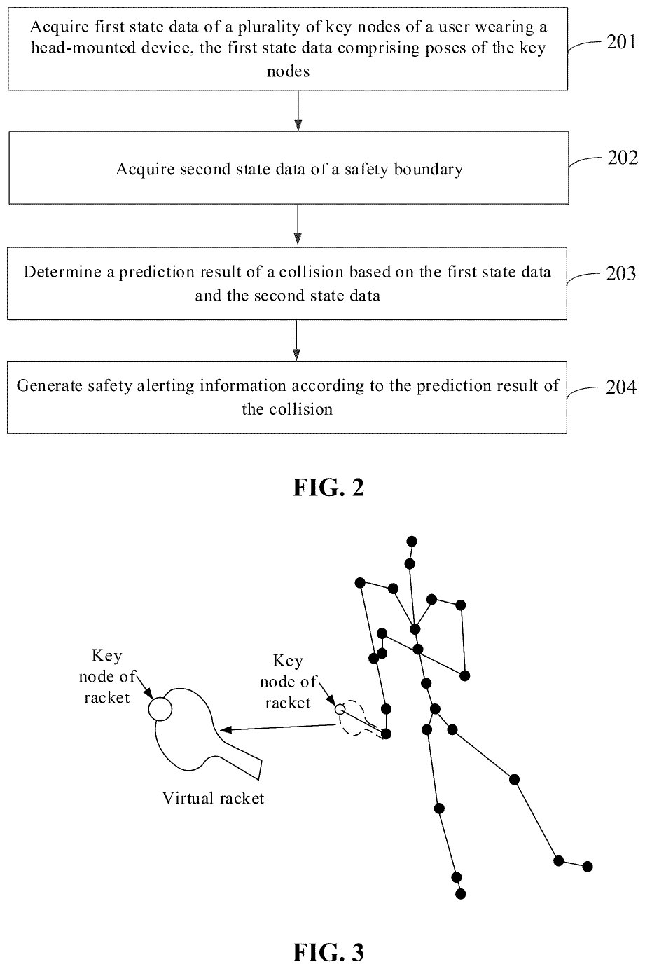

FIG. 2 illustrates a first flow chart of a safety alerting method according to an embodiment of the present disclosure. The method of the present embodiment may be applied to a terminal device (a tablet computer, a computer or the head-mounted device as shown in FIG. 1, etc.) or a server. The safety alerting method comprises:
201: first state data of a plurality of key nodes of a user wearing a head-mounted device is acquired; the first state data comprises poses of the key nodes.

In the embodiment of the present disclosure, the plurality of key nodes may comprise human skeletal nodes, as shown in FIG. 1, which may include nodes of a torso (which may include the chest, buttocks, etc.) indicated by black dots, upper limbs (which may include the elbows, hands, etc.) indicated by green dots, lower limbs (which may include the feet, knees, etc.) indicated by blue dots, the head indicated by red dots, etc.

In one embodiment of the present disclosure, since the poses of the key nodes are only static data such as positions and orientations, dynamic data may be added to improve the accuracy in collision prediction. Specifically, the first state data may further comprise motion information of the key nodes. The motion information of the key nodes may be determined by means of identifying a plurality of successive images, and the motion information of the head-mounted device (or a target device such as a controller) may also be determined based on sensing data captured by sensors such as an accelerometer and an inertial measurement unit provided on the head-mounted device (or the target device such as the controller). The motion information of the key nodes may then be determined based on the motion information.

In embodiments of the present disclosure, the first state data of the plurality of key nodes may be determined in multiple ways.

In one implementation, the acquiring first state data of a plurality of key nodes of a user wearing a head-mounted device may comprise: acquiring a target image captured by the head-mounted device; the target image comprises a plurality of said key nodes; and parsing the target image based on a deep learning model, to obtain first state data of the plurality of key nodes.

Specifically, the head-mounted device may be provided with a camera for capturing an image downward (“downward” refers to the orientation where the camera of the worn head-mounted device points diagonally downward when the user stands upright on the ground with a forward-facing gaze). When the user moves with the head-mounted device, an image is captured by the camera, and a human body and/or accessories (e.g., a racket, a baseball bat) held or worn by the user appear in the image. The poses and motion information (a motion speed, an acceleration, etc.) of the plurality of key nodes of the human body or accessories may be obtained by parsing the image, and then the motion trajectories of the key nodes may be estimated for collision prediction. Exemplarily, the image may be input to a deep learning model by which the image is parsed. The deep learning model is obtained by training according to a plurality of historical images. The historical images comprise different poses of the plurality of key nodes.

In another implementation, the acquiring first state data of a plurality of key nodes of a user wearing a head-mounted device may comprise: acquiring third state data of the head-mounted device and fourth state data of a target device associated with the head-mounted device; the third state data comprises the pose of the head-mounted device; determining the first state data of the plurality of key nodes of an interactor according to the third state data and the fourth state data based on an inverse kinematics algorithm.

The third state data may comprise the pose and the motion information of the head-mounted device. Association between the head-mounted device and the target device means that they both may be used in cooperation (e.g., they are both worn on the user's body simultaneously, and their poses vary with the user's motion), or mean that data interaction exists between the head-mounted device and the target device.

In an embodiment of the present disclosure, the target device comprises at least one of: a first device disposed on the user's upper limb, a second device disposed on the user's lower limb, and a third device disposed on a user-carried accessory. In one implementation, the target device (which may be, for example, a controller) may be disposed on the upper limb of the user's body, and the fourth state data comprises the pose and the motion information of the target device. In another implementation, the target device comprises the first device (e.g., a controller, a motion capture device having an independent tracking mode) and the second device (e.g., a motion capture device having a whole-body motion capture mode, or an IMU sensor), the first device being disposed on the upper limb of the user's body, and the second device being disposed on the lower limb of the user's body; the fourth state data comprises the pose of the first device and the pose of the second device. In a further implementation, on the basis of the above two manners, the target device further comprises a third device (e.g., a motion capture device) on a user-carried accessory (e.g., a racket, a baseball bat).

In yet another implementation, the acquiring first state data of a plurality of key nodes of a user wearing a head-mounted device may comprise: acquiring first sensing data of the head-mounted device and second sensing data of the target device associated with the head-mounted device; the target device comprises a first device disposed on an upper limb of the user's body, and/or, a second device disposed on a lower limb of the user's body; determining first state data of the plurality of key nodes of an interactor according to the first sensing data and the second sensing data based on a multi-modal algorithm.

Specifically, the head-mounted device may be provided with a vision sensor, a time-of-flight sensor, an inertial measurement unit, a gyroscope, a magnetometer, an accelerometer, a Global Positioning System (GPS) sensor, etc. The target device may be provided with an accelerometer, a gyroscope, a magnetometer, an optical sensor, a touch sensor, an eye movement tracking sensor, an audio sensor, etc. Through the multi-modal algorithm, the poses and optionally, the motion information of the plurality of key nodes may be obtained by directly using the sensing data captured by the sensor of the head-mounted device and the sensor of the target device. By this implementation, the poses of the plurality of key nodes may be obtained directly from the sensor data, and the computational efficiency and accuracy can be improved.

In one embodiment of the present disclosure, the plurality of key nodes may comprise skeletal nodes of the user's body, and/or key nodes of the user-carried accessory.

As shown in FIG. 3, the key nodes comprise not only skeletal nodes of the human body shown by black dots, but also key nodes of the racket shown by yellow dots. In one implementation, when the user holds a racket for a game, a target device (e.g., a motion capture device) may be provided on the racket. Since the target device and the racket have a fixed positional relationship, the poses of the key nodes of the racket may be acquired based on the target device, and the shape of the racket may be matched. In another implementation, the image may be captured by a downward-facing camera of the head-mounted device, the image including the key nodes of the racquet, and the poses of the key nodes of the racket may be determined based on the captured image.

202: second state data of a safety boundary is acquired.

Specifically, the safety boundary may be a preset virtual boundary or a real boundary formed by a surface of a real object in a real environment.

In a first embodiment of the present disclosure, the safety boundary is a preset virtual boundary; the second state data comprises boundary information of the virtual boundary.

Specifically, the virtual boundary may be user-defined and may also be set by the system of the head-mounted device based on a preset algorithm. The virtual boundary may be a vertical columnar boundary perpendicular to a plane where the ground is located. The ground of the columnar boundary maybe of a regular shape, e.g., a cylindrical shape, but may also be of an irregular shape, e.g., a columnar shape with an irregular bottom surface generated based on a user-drawn sketch or a ground obstacle.

In one embodiment of the present disclosure, the safety boundary is a real boundary formed by an object in the real environment; the second state data comprises surface information of the object in the real environment. Specifically, the acquiring second state data of a safety boundary comprises: acquiring second state data of the object in the real environment; the second state data comprises surface information of the object.

Specifically, the object in the real environment may be a living being such as a human being, a pet, etc. and may also be a non-living being such as a table, a chair, a sofa, a wall, an infant stroller, etc.

In one embodiment of the present disclosure, the surface of the object in the real environment may be detected by all sensors on the head-mounted device. The detection may be formula-based, machine learning-based, manually calibrated by the user, notified by the user, or automatically detected in the event of occurrence of a hazard, and may even be globally networked, or notified or calibrated by other users. In the future, measurement and calculation may also be performed outdoors based on a map or panorama on the Internet, vehicle position may be calculated according to real-time traffic data, outdoor obstacles, buildings and vehicles may be detected in advance, and a more reasonable interactor collision mechanism for outdoor may be designed, for example, the approaching of the vehicles may be detected and alerted in advance.

In one embodiment of the present disclosure, the acquiring second state data of an object in a real environment may comprise: acquiring third sensing data of the head-mounted device (a vision sensor, a time-of-flight sensor, etc.); and performing mesh reconstruction on the surface of the object in the real environment according to the position information of the surface of the object in the real environment, to obtain the second state data of the object in the real environment. Optionally, the performing mesh reconstruction on the surface of the object in the real environment according to the position information of the surface of the object in the real environment, to obtain the second state data of the object in the real environment may comprise: determining the position information of the surface of the object in the real environment according to the third sensing data based on a neural network model; based on a spatial mesh technology, performing reconstruction on the surface of the object in the real environment according to the position information of the surface of the object in the real environment, to obtain the second state data of the object in the real environment.

Specifically, the third sensing data may be acquired by all the sensors of the head-mounted device, and the mesh reconstruction of the surface of the object in the real environment may be performed according to the third sensing data. To improve efficiency, positions of surfaces of all objects in the real physical space may be detected in conjunction with a computer vision technology based on neural network learning during the mesh reconstruction. For an object only having partial surface, a partial surface reconstruction technology (a process of restoring the surface of the object from a series of observation images or other types of data) may be employed to restore the surface of the object, and a mesh may be reconstructed for the surface of the object in the space based on the spatial mesh technology. The mesh, as a series of triangular facet information, may be used to calculate the position and surface information of the object in the space.

203: a prediction result of a collision is determined based on the first state data and the second state data.

Specifically, after acquiring the poses of the plurality of key nodes and the position and surface information of the objects in the real physical space, a positional relationship between the plurality of key nodes and surfaces of adjacent objects may be monitored. Then, whether the collision will occur, a timing and a position where the collision will occur may be predicted according to the positional relationship, to obtain the prediction result of the collision. The prediction result of the collision may include a predicted position where the collision will occur, or a time point at which the collision will occur, etc. Since the prediction result of the collision is determined based on the poses of the key nodes, i.e., the prediction result of the collision is determined based on a more detailed portion (e.g., a foot, a knee, an elbow or the like) of a human body, the determination of the prediction result of the collision based on the pose of the head-mounted device or controller can achieve a more accurate prediction result of the collision as compared with the determination of the prediction result of the collision by taking the head-mounted device or controller as a whole.

204: safety alerting information is generated according to the prediction result of the collision.

Specifically, after the prediction result of the collision is acquired, the safety alerting information may be generated based on a predicted position (and a predicted time point) indicated by the prediction result of the collision. A main purpose of the safety alerting is to alert the user to an imminent danger. Safety alert information may take various forms. For example, some virtual mesh alerts may be displayed in the space, a safety boundary fence may be displayed to prompt the user, the real-world environment may be passed through to enable the user to see a dangerous situation in the real-world environment, or a prompt box may be provided. To achieve a more eye-catching effect, the safety alert information may be provided at the predicted position where the collision might occur, for example, the mesh data at the predicted position may be displayed, the safety boundary fence at the predicted position may be displayed, the real-world environment at the predicted position may be passed through, the prompt box may be displayed at the predicted position, etc. It should be noted that to avoid the interruption of the user's use, the head-mounted device further displays virtual content. The safety alert information such as virtual mesh, the safety boundary fence and the prompt box may be displayed together with the virtual content. When the safety alert is achieved by passing through the real-world environment, the passthrough may be performed from part of the virtual content to avoid affecting the user's use as much as possible.

In one embodiment of the present disclosure, different safety alert information may be generated according to different indoor and outdoor scenarios, and may be set by the user on his own. The safety alert information may transparently or semi-transparently display a dangerous scenario or object, or representing a dangerous scenario with other colors, animated effects and meshes, or prompting the user with a more obvious pop-up window, or prompting the user with other speeches.

In one embodiment of the present disclosure, the prediction result of the collision comprises a predicted position where the collision occurs, and the generating safety alert information according to the prediction result of the collision may comprise at least one of the following items: a first item, i.e., displaying mesh data at a corresponding position in the surface of the object in the corresponding real environment according to the predicted position; a second item, i.e., passing through the real environment at the corresponding position according to the predicted position; a third item, i.e., displaying prompt information at the predicted position.

As known from the above depictions, the safety alerting method according to the embodiments of the present disclosure, by performing collision prediction according to more detailed data of the poses of the plurality of key nodes of the user and the safety boundary, can obtain a prediction result with a higher accuracy, improve the accuracy and effectiveness of the safety alerting, can not only avoid excessive interruptions to the user but also effectively ensure the user's safety, and improve the user's experience in use.

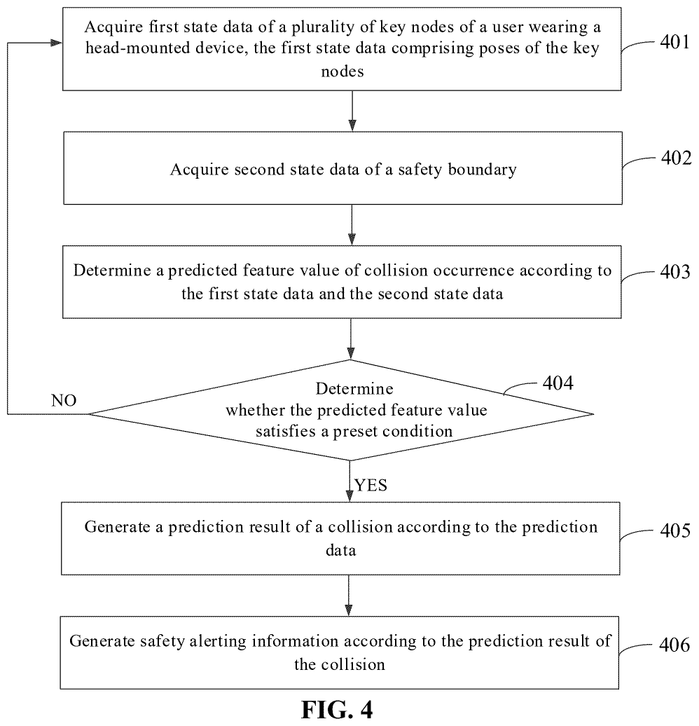

FIG. 4 illustrates a second flow chart of a safety alerting method according to an embodiment of the present disclosure. Based on the above embodiment of the present disclosure, e.g., on the basis of the embodiment disclosed in FIG. 2, the present embodiment of the present disclosure describes the manner of generating the prediction result of the collision in detail. The method comprises:
401: first state data of a plurality of key nodes of a user wearing a head-mounted device is acquired; the first state data comprises a pose of the a key node.
402: second state data of a safety boundary is acquired.

In the present embodiment of the present disclosure, steps 401 and 402 are similar to steps 201 and 202 in the above embodiment of the present disclosure, and will not be described in detail any more here.
403: a predicted feature value of collision occurrence is determined according to the first state data and the second state data.
404: whether the predicted feature value satisfies a preset condition is determined; if YES, step 405 is executed; or if NO, return and step 401 is executed.
405: a prediction result of a collision is generated according to the predicted feature value.

Specifically, after the first state data of the plurality of key nodes and the position and surface information of the object in the real physical space are obtained, whether there is a key node that will imminently collide with the surface of the object in the real physical space may be calculated according to these data. In order to improve the flexibility, a certain screening mechanism may be introduced into a degree of imminent occurrence, i.e., a degree to which the prediction result of the collision is generated, to achieve different calculation manners. The screening mechanism may be designed by considering many types of factors such as a human body state, a processing delay (a period of time spent in processing before the safety alert information is pushed to the user), a use intention of the user currently using the head-mounted device, a time dimension, a distance dimension, etc.

In one embodiment of the present disclosure, the determining a prediction result of a collision according to the first state data and the second state data may comprise: determining a predicted feature value of collision occurrence according to the first state data and the second state data; generating the prediction result of the collision according to the predicted feature value if the predicted feature value satisfies the preset condition.

Specifically, a predicted feature value such as a time point at which the collision will occur or a position where the collision will occur may be first determined, and then a screening condition is set for the predicted feature value. When the preset condition is satisfied, the prediction result of the collision is generated.

In one implementation, the determining a predicted feature value of collision occurrence according to the first state data and the second state data may comprise: determining a predicted position where the collision will occur and a corresponding key node where the collision is predicted to occur, according to the first state data and the second state data; the generating the prediction result of the collision according to the predicted feature value if the predicted feature value satisfies the preset condition may comprise: generating the prediction result of the collision according to the predicted position if a distance between the predicted position and the key node where the collision is predicted to occur is smaller than a preset distance.

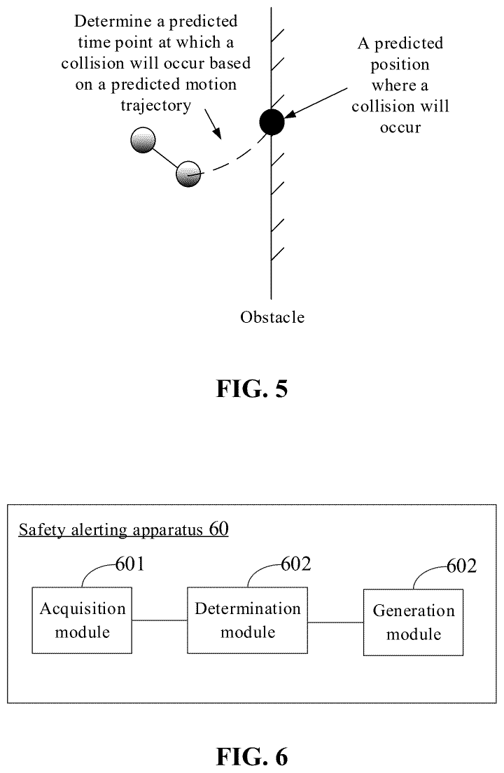

Exemplarily, as shown in FIG. 5, after the first state data (pose and/or motion information) of the footstep key node is obtained, a motion trajectory is predicted according to the first state data, and the predicted position where the collision will occur may be determined based on the motion trajectory. The distance between the predicted position and the key node where the collision will occur may be a straight-line distance, or a trajectory length along a predicted trajectory. If the distance between the predicted position and the key node where the collision is predicted to occur is smaller than the preset distance, this indicates that a danger coefficient is already higher, the user needs to be alerted, and therefore the prediction result of the collision is generated.

In another implementation, the determining a predicted feature value of collision occurrence according to the first state data and the second state data may comprise: determining a predicted time point and a predicted position where the collision will occur, according to the first state data and the second state data; if a time length between a current time point and the predicted time point is smaller than a preset time length, generating the prediction result of the collision according to the predicted time point and the predicted position.

Exemplarily, as shown in FIG. 5, after the first state data (pose and/or motion information) of the footstep key node is obtained, the motion trajectory may be predicted according to the first state data, and the predicted time point at which the collision occurs may be determined based on the motion trajectory. If the time length between the current time point and the predicted time point is smaller than the preset time length, this indicates that the danger coefficient is already higher, the user needs to be alerted, and therefore the prediction result of the collision is generated.

In one embodiment of the present disclosure, since the human body exhibits different response sensitivity when in different states, the timeliness of the collision alert might vary to improve the user's experience. Specifically, before generating the prediction result of the collision according to the predicted feature value if the predicted feature value satisfies the preset condition, the method may further comprise: acquiring the user's state information, the state information comprising the user's action sensitivity; determining the preset condition according to the state information.

Specifically, regarding an estimate of the user's state, a solution of machine learning may be introduced, or the user may select by himself. Exemplarily, the user's profile may be determined according to the user's use data in the head-mounted device, for example, a time window in which the user likes performing a high-sensitivity activity (a game such as a first-person shooter game or a boxing game) and the activity effect, a time window in which the user performs a low-sensitivity activity (e.g., cinematic viewing, 3D environment exploration etc.) and the activity effect. Then, factors (a time window, a game type, etc.) associated with the user state information maybe determined based on the user's profile. Different factor combinations correspond to different states. When a certain factor combination occurs, it is determined that the user belongs to a corresponding state, thereby determining a corresponding preset condition. Typically, the better the state is, the more difficultly the preset condition is satisfied. The reason is that the user's response speed is quick, and it is unnecessary to alert the user especially beforehand.

In one embodiment of the present disclosure, the determining a prediction result of a collision based on the first state data and the second state data may comprise: acquiring the user's interaction data in the head-mounted device; determining the user's use intention according to the interaction data; if the user's use intention is a preset intention, adjusting the preset condition to improve a generation frequency of prediction results of the collision.

The interaction data may comprise virtual consumption information (about buying boxing gloves, movie tickets, etc.), a type of application being used (e.g., a boxing game requiring more actions to be made, or a movie-viewing application not requiring more actions to be made), etc. The user's use intention may be determined based on the interaction data. When the user's use intention is to play a boxing game, the collision risk will be further increased, and an alert may be issued in advance. When the user's use intention is to view a movie, the collision is almost unlikely to occur, whereupon the alert may be mitigated, or the collision detection function may be closed to save the resources. When the user's use intention changes, the collision detection function will be activated again.

406: safety alerting information is generated according to the prediction result of the collision.

In the embodiment of the present disclosure, step 406 is similar to step 204 in the above embodiment of the present disclosure, and will not be described in detail any more here.

As known from the above depictions, based on the safety alerting method according to the embodiment of the present disclosure, the screening mechanism is designed, screening is performed based on the predicted feature value to generate the prediction result of the collision to achieve a balance between the reduction of the interruption and the improvement of safety.

Corresponding to the safety alerting method in the above embodiment, FIG. 6 illustrates a block diagram of a safety alerting apparatus according to an embodiment of the present disclosure. For ease of description, FIG. 6 only shows portions related to the present embodiment of the present disclosure. Referring to FIG. 6, the apparatus comprises: an acquisition module 601, a determination module 602 and a generation module 603.

The acquisition module 601 is configured to acquire first state data of a plurality of key nodes of a user wearing a head-mounted device, the first state data comprising a pose of a key node;

The acquisition module 601 is further configured to acquire second state data of a safety boundary;

The determination module 602 is configured to determine a prediction result of a collision based on the first state data and the second state data;

The generation module 603 is configured to generate safety alerting information according to the prediction result of the collision.

In one embodiment of the present disclosure, the first state data further comprises motion information of key nodes.

In one embodiment of the present disclosure, the acquisition module 601, when acquiring the first state data of the plurality of key nodes of the user wearing the head-mounted device, is specifically configured to: acquire a target image captured by the head-mounted device, the target image comprising a plurality of said key nodes; and parse the target image based on a deep learning model, to obtain first state data of the plurality of key nodes.

In one embodiment of the present disclosure, the acquisition module 601, when acquiring the first state data of the plurality of key nodes of the user wearing the head-mounted device, is specifically configured to: acquire third state data of the head-mounted device and fourth state data of a target device associated with the head-mounted device, the third state data comprising the pose of the head-mounted device; determine the first state data of the plurality of key nodes of an interactor according to the third state data and the fourth state data based on an inverse kinematics algorithm.

In an embodiment of the present disclosure, the target device comprises at least one of: a first device disposed on the user's upper limb, a second device disposed on the user's lower limb, and a third device disposed on a user-carried accessory.

In one embodiment of the present disclosure, the acquisition module 601, upon acquiring the first state data of the plurality of key nodes of the user wearing the head-mounted device, is specifically configured to: acquire first sensing data of the head-mounted device and second sensing data of the target device associated with the head-mounted device, the target device comprising a first device disposed on an upper limb of the user's body, and/or, a second device disposed on a lower limb of the user's body; determine first state data of the plurality of key nodes of an interactor according to the first sensing data and the second sensing data based on a multi-modal algorithm.

In one embodiment of the present disclosure, the plurality of key nodes comprise skeletal nodes of the user's body, and/or key nodes of the user-carried accessory.

In one embodiment of the present disclosure, the safety boundary is a preset virtual boundary; the second state data comprises boundary information of the virtual boundary.

In one embodiment of the present disclosure, the safety boundary is a real boundary formed by an object in a real environment; the second state data comprises surface information of the object in the real environment.

In one embodiment of the present disclosure, the acquisition module 601, upon acquiring the second state data of the safety boundary, is specifically configured to: acquire third sensing data of the head-mounted device; and perform reconstruction on the surface of the object in the real environment according to the position information of the surface of the object in the real environment, to obtain the second state data of the object in the real environment.

In one embodiment of the present disclosure, the determination module 602, upon determining the prediction result of the collision according to the first state data and the second state data, is specifically configured to: determine a predicted feature value of collision occurrence according to the first state data and the second state data; generate the prediction result of the collision according to the predicted feature value if the predicted feature value satisfies a preset condition.

In one embodiment of the present disclosure, the determination module 602, upon determining the predicted feature value of collision occurrence according to the first state data and the second state data, is specifically configured to: determine a predicted position where the collision will occur and a corresponding key node where the collision is predicted to occur, according to the first state data and the second state data; generate the prediction result of the collision according to the predicted position if a distance between the predicted position and the key node where the collision is predicted to occur is smaller than a preset distance.

In one embodiment of the present disclosure, the determination module 602, upon determining the predicted feature value of collision occurrence according to the first state data and the second state data, is specifically configured to: determine a predicted time point and a predicted position where the collision will occur, according to the first state data and the second state data; if a time length between a current time point and the predicted time point is smaller than a preset time length, generate the prediction result of the collision according to the predicted time point and the predicted position.

In one embodiment of the present disclosure, the determination module 602, before generating the prediction result of the collision according to the predicted feature value if the predicted feature value satisfies the preset condition, is further configured to: acquire the user's state information, the state information comprising the user's action sensitivity; and determine the preset condition according to the state information.

In one embodiment of the present disclosure, the determination module 602, upon determining the prediction result of the collision according to the first state data and the second state data, is specifically configured to: acquire the user's interaction data in the head-mounted device; determine the user's use intention according to the interaction data; if the user's use intention is a preset intention, adjust the preset condition to improve a generation frequency of the prediction results of the collision.

In one embodiment of the present disclosure, the generation module 603, upon generating safety alert information according to the prediction result of the collision when the prediction result of the collision comprises a predicted position where the collision occurs, is specifically used to perform at least one of the following items: displaying mesh data at a corresponding position in the surface of the object in the corresponding real environment according to the predicted position; passing through the real environment at the corresponding position according to the predicted position; displaying prompt information at the predicted position.

The apparatus according to the present embodiment may be used to implement the technical solution of the above method embodiment, and the implementation principle and technical effects thereof are similar to those of the method embodiment and will not be described in detail any more in the present embodiment.

To implement the above embodiments, an embodiment of the present disclosure further provides an electronic device.

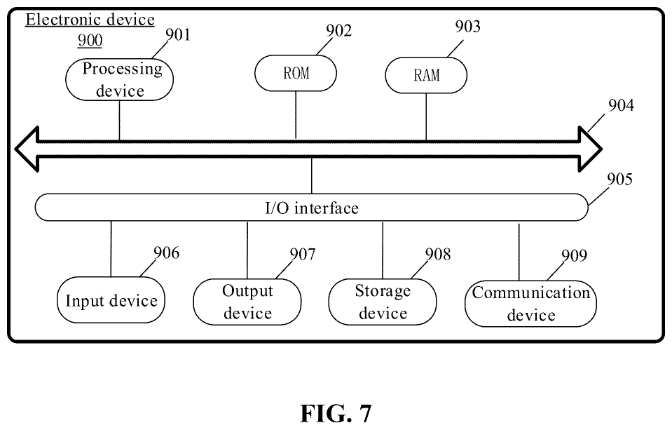

Referring to FIG. 7, which illustrates a schematic diagram of an electronic device 900 adapted to implement embodiments of the present disclosure. The electronic device 900 may be a terminal device or a server. The terminal device includes but not limited to mobile terminals such as mobile phones, notebook computers, digital broadcast receivers, Personal Digital Assistants (PDAs), Tablet Computers (Portable Android Devices, PADs), Portable Multimedia Players (PMPs), in-vehicle terminals (e.g., in-vehicle navigation terminals), etc. and fixed terminals such as digital TVs, desktop computers, etc. The electronic device shown in FIG. 7 is merely an example and should not impose any limitations on the functionality and scope of use of embodiments of the present disclosure.

As shown in FIG. 7, the electronic device 900 may comprise a processing device (e.g., a central processing unit, a graphics processing unit, etc.) 901 that may perform various suitable acts and processes in accordance with a program stored in a Read Only Memory (ROM) 902 or a program loaded from a storage device 908 into a Random Access Memory (RAM) 903. In the RAM 903, various programs and data needed by the operation of the electronic device 900 are also stored. The processing device 901, the ROM 902, and the RAM 903 are connected to one another via a bus 904. An input/output (I/O) interface 905 is also coupled to the bus 904.

In general, the following devices may be connected to the I/O interface 905: an input device 906 including, for example, a touch screen, a touch pad, a keyboard, a mouse, a camera, a microphone, an accelerometer, a gyroscope, etc.; an output device 907 including, for example, a Liquid Crystal Display (LCD), a speaker, a vibrator, etc.; a storage device 908 including, for example, a magnetic tape, a hard disk, etc.; and a communication device 909. The communication device 909 may allow the electronic device 900 to communicate in a wireless or wired manner with other devices to exchange data. While FIG. 7 illustrates the electronic device 900 having various devices, it is to be understood that not all illustrated devices are required to be implemented or provided. More or fewer devices may alternatively be implemented or provided.

Especially, according to embodiments of the present disclosure, the processes described above with reference to flow charts may be implemented as computer software programs. For example, embodiments of the present disclosure comprise a computer program product comprising a computer program carried on a computer-readable medium, the computer program comprising program code for performing the method illustrated by the flow charts. In such embodiments, the computer program may be downloaded and installed from a network via the communication device 909, or installed from the storage device 908, or installed from the ROM 902. When the computer program is executed by the processing device 901, the above-described functions defined in the method of the embodiment of the present disclosure are performed.

It should be noted that the computer-readable medium described above in the present disclosure may be either a computer-readable signal medium or a computer-readable storage medium, or any combination of the two. The computer-readable storage medium may be, for example but not limited to, an electronic, magnetic, optical, electromagnetic, infrared, or semiconductor system, apparatus, or device, or a combination of any of the above. More specific examples of the computer-readable storage medium may comprise, but are not limited to: an electrical connection having one or more wires, a portable computer magnetic disk, a hard disk, a Random Access Memory (RAM), a Read-Only Memory (ROM), an Erasable Programmable Read-Only Memory (EPROM or Flash memory), an optical fiber, a Portable Compact Disk Read-Only Memory (CD-ROM), an optical storage device, a magnetic storage device, or any suitable combination of the above. In the present disclosure, the computer-readable storage medium may be any tangible medium that contains or stores aprogram that may be used by or in conjunction with an instruction execution system, apparatus, or device. In the present disclosure, the computer-readable signal medium may comprise a data signal embodied in baseband or propagated as part of a carrier carrying computer-readable program code. Such propagated data signals may take many forms, including but not limited to, electromagnetic signals, optical signals, or any suitable combinations thereof. The computer-readable signal medium may also be any computer-readable medium other than a computer-readable storage medium that may send, propagate, or transport the program for use by or for use in conjunction with the instruction execution system, apparatus, or device. The program code contained on the computer-readable medium may be transmitted with any suitable medium including, but not limited to: electrical wire, optic cable, RF (radio frequency), and the like, or any suitable combinations thereof.

The computer readable medium may be contained in the above-described electronic device; it may also be present separately and not installed into the electronic device.

The computer-readable medium carries one or more programs that, when executed by the electronic device, cause the electronic device to perform the methods described in the above embodiments.

The computer program code for carrying out operations of the present disclosure may be written in one or more programming languages or combinations thereof. The programming languages include, but not limited to, object-oriented programming languages, such as Java, smalltalk, C++, and conventional procedural programming languages, such as the “C” language or similar programming languages. The program code may be executed entirely on the user's computer, executed partly on the user's computer, executed as a stand-alone software package, executed partly on the user's computer and partly on a remote computer, or executed entirely on the remote computer or a server. In the case of the remote computer, the remote computer may be connected to the user's computer through any type of network, including a local area network (LAN) or a wide area network (WAN), or it may be connected to an external computer (e.g., connected through the Internet using an Internet service provider).

The flowchart and block diagrams in the figures illustrate the architecture, functionality, and operation of possible implementations of systems, methods and computer program products according to various embodiments of the present invention. In this regard, each block in the flowchart or block diagrams may represent a module, program segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It should also be noted that each block of the block diagrams and/or flowchart illustration, and combinations of blocks in the block diagrams and/or flowchart illustration, may be implemented by dedicated hardware-based systems that perform the specified functions or operations, or combinations of dedicated hardware and computer instructions.

The units described in connection with the embodiments disclosed herein may be implemented in a software or hardware manner. The names of the units do not constitute limitations of the units themselves in a certain case, for example, the first acquisition unit may be described as “a unit for acquiring at least two internet protocol addresses”.

The functions described herein above may be performed, at least in part, by one or more hardware logic constituent elements. For example, without limitation, exemplary types of hardware logic constituent elements that may be used comprise: a Field Programmable Gate Array (FPGA), an Application Specific Integrated Circuits (ASIC), an Application Specific Standard Products (ASSP), a Systems On Chip (SOC), a Complex Programmable Logic Device (CPLD), and so on.

In the context of the present disclosure, the machine-readable medium may be a tangible medium that may contain or store a program for use by or for use in conjunction with an instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combinations thereof. More specific examples of the machine-readable storage medium would comprise an electrical connection based on one or more wires, a portable computer diskette, a hard disk, a Random Access Memory (RAM), a Read-Only Memory (ROM), an Erasable Programmable Read-Only Memory (EPROM or Flash memory), an optical fiber, a Compact Disc Read-Only Memory (CD-ROM), an optical storage device, a magnetic storage device, or any suitable combination thereof.

The foregoing description is only illustrative of preferred embodiments of the present disclosure and of the principles of the technology employed. It will be appreciated by those skilled in the art that the scope of the present disclosure is not limited to technical solutions formed by specific combinations of the above technical features, and meanwhile covers other technical solutions formed by any combinations of the above technical features or other equivalent features, for example, technical solutions formed by mutual replacement of the above features and technical features having similar functions disclosed in (not limited to) the present disclosure, without departing from the concept disclosed above.

In addition, while operations are depicted in a particular order, this should not be understood as requiring that such operations are performed in the particular order shown or in sequential order. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in the context of a single implementation may also be implemented in multiple implementations separately or in any suitable sub-combination.

Although the subject matter has been described in language specific to structural features and/or methodological actions, it should be understood that the subject matters specified in the appended claims are not limited to the specific features or actions described above. Rather, the specific features and actions described above are disclosed as example forms of implementing the claims.

I/We claim:

1. A safety alerting method, comprising:
acquiring first state data of a plurality of key nodes of a user wearing a head-mounted device, the first state data comprising a pose of a key node;
acquiring second state data of a safety boundary;
determining a prediction result of a collision based on the first state data and the second state data; and
generating safety alerting information based on the prediction result of the collision.

2. The method according to claim 1, wherein the first state data further comprises motion information of the key node.

3. The method according to claim 1, wherein acquiring the first state data of the plurality of key nodes of the user wearing the head-mounted device comprises:
acquiring a target image captured by the head-mounted device, the target image comprising the plurality of key nodes; and
parsing the target image based on a deep learning model, to obtain the first state data of the plurality of key nodes.

4. The method according to claim 1, wherein acquiring the first state data of the plurality of key nodes of the user wearing the head-mounted device comprises:
acquiring third state data of the head-mounted device and fourth state data of a target device associated with the head-mounted device, the third state data comprising a pose of the head-mounted device; and
determining the first state data of the plurality of key nodes of an interactor according to the third state data and the fourth state data based on an inverse kinematics algorithm.

5. The method according to claim 4, wherein the target device comprises at least one of: a first device disposed on the user's upper limb, a second device disposed on the user's lower limb, or a third device disposed on a user-carried accessory.

6. The method according to claim 1, wherein acquiring the first state data of the plurality of key nodes of the user wearing the head-mounted device comprises:
acquiring first sensing data of the head-mounted device and second sensing data of a target device associated with the head-mounted device, the target device comprising at least one of: a first device disposed on an upper limb of the user's body, or a second device disposed on a lower limb of the user's body; and
determining the first state data of the plurality of key nodes of an interactor according to the first sensing data and the second sensing data based on a multi-modal algorithm.

7. The method according to claim 1, wherein the plurality of key nodes comprise at least one of: skeletal nodes of the user's body, or key nodes of a user-carried accessory.

8. The method according to claim 1, wherein the safety boundary is a preset virtual boundary; and the second state data comprises boundary information of the virtual boundary.

9. The method according to claim 1, wherein the safety boundary is a real boundary formed by an object in a real environment; and the second state data comprises surface information of the object in the real environment.

10. The method according to claim 9, wherein acquiring the second state data of the safety boundary comprises:
acquiring third sensing data of the head-mounted device; and
performing reconstruction on a surface of the object in the real environment based on position information of the surface of the object in the real environment, to obtain the second state data of the object in the real environment.

11. The method according to claim 1, wherein determining the prediction result of the collision based on the first state data and the second state data comprises:
determining a predicted feature value of a collision occurrence based on the first state data and the second state data; and
generating the prediction result of the collision based on the predicted feature value, in response to the predicted feature value satisfying a preset condition.

12. The method according to claim 11, wherein determining the predicted feature value of the collision occurrence based on the first state data and the second state data comprises:
determining a predicted position where the collision will occur and a corresponding key node where the collision is predicted to occur, based on the first state data and the second state data; and
wherein generating the prediction result of the collision based on the predicted feature value, in response to the predicted feature value satisfying the preset condition comprises;
generating the prediction result of the collision based on the predicted position, in response to a distance between the predicted position and the key node where the collision is predicted to occur being smaller than a preset distance.

13. The method according to claim 11, wherein determining the predicted feature value of the collision occurrence based on the first state data and the second state data comprises:
determining a predicted time point and a predicted position where the collision will occur, based on the first state data and the second state data; and
wherein generating the prediction result of the collision based on the predicted feature value, in response to the predicted feature value satisfying the preset condition comprises;
in response to a time length between a current time point and the predicted time point being smaller than a preset time length, generating the prediction result of the collision based on the predicted time point and the predicted position.

14. The method according to claim 11, further comprising: before generating the prediction result of the collision based on the predicted feature value, in response to the predicted feature value satisfying the preset condition,
acquiring the user's state information, the state information comprising the user's action sensitivity; and
determining the preset condition based on the state information.

15. The method according to claim 11, wherein determining the prediction result of the collision based on the first state data and the second state data comprises:
acquiring the user's interaction data in the head-mounted device;
determining the user's use intention based on the interaction data; and
in response to the user's use intention being a preset intention, adjusting the preset condition to increase a generation frequency of the prediction results of the collision.

16. The method according to claim 1, wherein the prediction result of the collision comprises a predicted position where the collision occurs, and wherein generating the safety alerting information based on the prediction result of the collision comprises at least one of the following:
displaying mesh data at a corresponding position in a surface of an object in a corresponding real environment based on the predicted position;
performing passthrough a real environment at the corresponding position based on the predicted position; and
displaying prompt information at the predicted position.

17. An electronic device, wherein the electronic device comprises: a processor and a memory:
the memory stores computer-executable instructions; and
the processor executes the computer-executable instructions stored in the memory to cause the processor to:
acquire first state data of a plurality of key nodes of a user wearing a head-mounted device, the first state data comprising a pose of a key node;
acquire second state data of a safety boundary;
determine a prediction result of a collision based on the first state data and the second state data; and
generate safety alerting information based on the prediction result of the collision.

18. The electronic device according to claim 17, wherein the first state data further comprises motion information of the key node.

19. The electronic device according to claim 17, wherein the computer-executable instructions to acquire the first state data of the plurality of key nodes of the user wearing the head-mounted device comprise instructions to:
acquire a target image captured by the head-mounted device, the target image comprising the plurality of key nodes; and
parse the target image based on a deep learning model, to obtain the first state data of the plurality of key nodes.

20. A non-transitory computer-readable storage medium, wherein the computer-readable storage medium has stored therein computer-executable instructions which, when executed by a processor, cause a computer to:
acquire first state data of a plurality of key nodes of a user wearing a head-mounted device, the first state data comprising a pose of a key node;
acquire second state data of a safety boundary;
determine a prediction result of a collision based on the first state data and the second state data; and
generate safety alerting information based on the prediction result of the collision.
